(19) United States
(12) Patent Application Publication
(10) Pub. No.: US 2006/0113895 A1
(43) Pub. Date: Jun. 1, 2006

(54) Light emitting device with multiple layers of quantum dots and method for making the device

(76) Inventors: Tajul Arosh Baroky, Penang (MY); Janet Bee Yin Chua, Perak (MY); Kok Chin Pan, Penang (MY); Kee Yean Ng, Penang (MY); Kheng Leng Tan, Penang (MY)

Correspondence Address: AVAGO TECHNOLOGIES, LTD., P.O. BOX 1920, DENVER, CO, 80201-1920, US

(21) Appl. No.: 10/999,352

(22) Filed: Nov. 30, 2004

(51) Int. Cl. H01J 1/62

(52) U.S. Cl. 313/501

(57) ABSTRACT

A light emitting device utilizes multiple layers of quantum dots to convert at least some of the original light emitted from a light source of the device to longer wavelength light to produce an output light. The light emitting device is made by forming the multiple layers of quantum dots over a light source and then forming an encapsulant over the multiple layers of quantum dots. The multiple layers of quantum dots can be used to produce broad-spectrum color light, such as white light.

### BACKGROUND OF THE INVENTION

Existing light emitting diodes (“LEDs”) can emit light in the ultraviolet (“UV”), visible or infrared (“IR”) wavelength range. These LEDs generally have narrow emission spectrum (approximately ±10 nm). As an example, a blue InGaN LED may generate light with wavelength of 470 nm±10 nm. As another example, a green InGaN LED may generate light with wavelength of 510 nm±10 nm. As another example, a red AlInGaP LED may generate light with wavelength of 630 nm±10 nm.

However, in some applications, it is desirable to use LEDs that can generate broader emission spectrums to produce desired color light, such as white light. Due to the narrow-band emission characteristics, these monochromatic LEDs cannot be directly used to produce broad-spectrum color light. Rather, the output light of a monochromatic LED must be mixed with other light of one or more different wavelengths to produce broad-spectrum color light. This can be achieved by introducing one or more photoluminescent materials into the encapsulant of a monochromatic LED to convert some of the original light into longer wavelength light through photoluminescence. The combination of original light and converted light produces broad-spectrum color light, which can be emitted from the LED as output light. The most common photoluminescent materials used to create LEDs that produce broad-spectrum color light are fluorescent particles made of phosphors, such as Garnet-based phosphors, Silicate-based phosphors, Orthosilicate-based phosphors, Sulfide-based phosphors, Thiogallate-based phosphors and Nitride-based phosphors. These phosphor particles are typically mixed with the transparent material used to form the encapsulants of LEDs so that original light emitted from the semiconductor die of an LED can be converted within the encapsulant of the LED to produce the desired output light.

Recently, quantum dots have also been used to create LEDs that produce broad-spectrum color light. Similar to phosphor particles, quantum dots are typically mixed with the transparent material used to form the encapsulants of LEDs. However, it is a challenge to use the proper types of quantum dots in proper proportions to produce the desired output light with respect to wavelength characteristics. In addition, quantum dots tend to agglomerate when mixed with the transparent material used to form the encapsulants of the LEDs. Thus, the output light color of the resulting LEDs may not be uniform. Furthermore, the intensity of the output light may be reduced due to the agglomeration of quantum dots.

In view of these concerns, there is a need for a light emitting device that produces output light using quantum dots that alleviates some or all of these concerns and method for making the device.

### SUMMARY OF THE INVENTION

A light emitting device utilizes multiple layers of quantum dots to convert at least some of the original light emitted from a light source of the device to longer wavelength light to produce an output light. The light emitting device is made by forming the multiple layers of quantum dots over a light source and then forming an encapsulant over the multiple layers of quantum dots. The multiple layers of quantum dots can be used to produce broad-spectrum color light, such as white light.

A device in accordance with an embodiment of the invention comprises a light source that emits original light, multiple layers of quantum dots positioned over the light source, the multiple layers being positioned to receive the original light and to convert at least some of the original light to converted light, the converted light being a component of an output light, and an encapsulant positioned over the multiple layers of quantum dots, the output light being emitted from the encapsulant. Each of the multiple layers includes quantum dots of a predefined particle size range.

A method for making a light emitting device in accordance with an embodiment of the invention comprises providing a light source, forming multiple layers of quantum dots over the light source, each of the multiple layers including quantum dots of a predefined particle size range, the multiple layers being used to convert at least some of original light emitted by the light source to control characteristics of output light of the light emitting device, and forming an encapsulant over the multiple layers of quantum dots.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a light emitting diode (LED) in accordance with an embodiment of the invention.

FIG. 2A shows the interstitial layers of a multi-layered region of quantum dots included in the LED of FIG. 1 in accordance with an embodiment of the invention.

FIG. 2B shows the interstitial layers of a multi-layered region of quantum dots included in the LED of FIG. 1 in accordance with another embodiment of the invention.

FIGS. 3A and 3B illustrate the process for fabricating the LED of FIG. 1 in accordance with an embodiment of the invention.

FIG. 4 is a diagram of a leadframe-mounted LED without a reflector cup in accordance with an embodiment of the invention.

FIG. 5 is a diagram of a surface mount LED with a reflector cup in accordance with an embodiment of the invention.

FIG. 6 is a diagram of a surface mount LED without a reflector cup in accordance with an embodiment of the invention.

FIG. 7 is a diagram of a light emitting diode (LED) with an open space filled with air between an LED die and an encapsulant in accordance with an embodiment of the invention.

FIG. 8 is a diagram of a light emitting diode (LED) with a planar multi-layered region of quantum dots in accordance with an embodiment of the invention.

FIG. 9 is a flow diagram of a method for making a light emitting device, such as an LED, in accordance with an embodiment of the invention.

### DETAILED DESCRIPTION

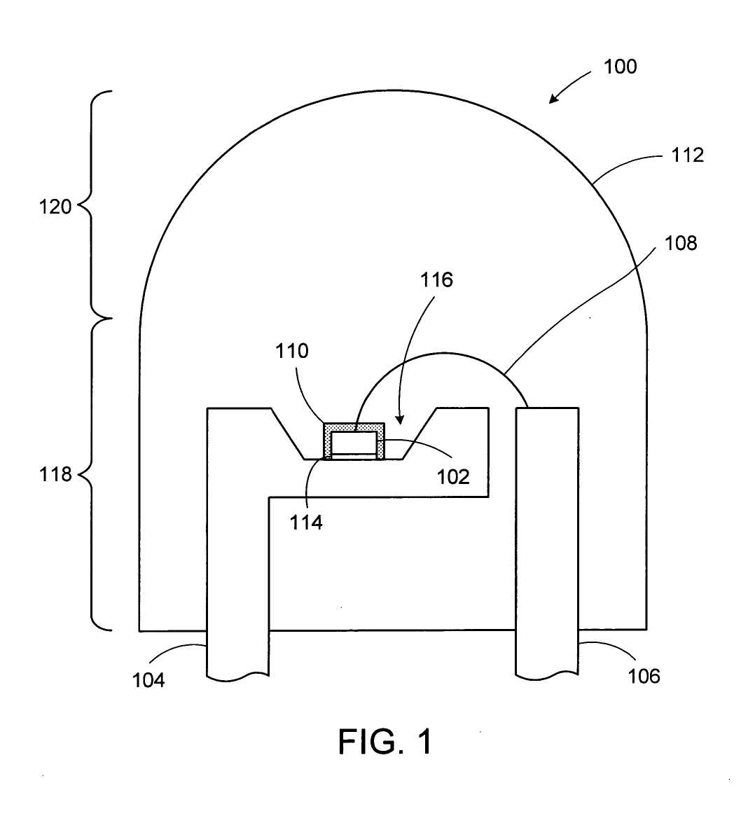

With reference to FIG. 1, a leadframe-mounted light emitting diode (LED) 100 in accordance with an embodiment of the invention is described. The LED 100 includes an LED die 102, leadframes 104 and 106, a bond wire 108, a multi-layered region 110 of quantum dots and an encapsulant 112. As described in more detail below, the distribution of quantum dots in the multi-layered region 110 are determined by the particle size of the quantum dots. Since the particle size of quantum dots partly determines the wavelength of light emitted from the quantum dots, the output light color of the LED 100 can be better controlled by an orderly distribution of quantum dots with respect to their particle size.

The LED die 102 is a semiconductor chip that generates light of a particular peak wavelength. Thus, the LED die 102 is a light source of the LED 100. The LED die 102 may be a deep ultraviolet (UV), UV, blue or green LED die. Although the LED 100 is shown in FIG. 1 as having only a single LED die, the LED may include multiple LED dies. The LED die 102 is attached or mounted on the upper surface of the leadframe 104 using an adhesive material 114, and electrically connected to the other leadframe 106 via the bond wire 108. The leadframes 104 and 106 are made of metal, and thus, are electrically conductive. The leadframes 104 and 106 provide the electrical power needed to drive the LED die 102.

In this embodiment, the leadframe 104 includes a depressed region 116 at the upper surface, which forms a reflector cup in which the LED die 102 is mounted. Since the LED die 102 is mounted on the leadframe 104, the leadframe 104 can be considered to be a mounting structure for the LED die. The surface of the reflector cup 116 may be reflective so that some of the light generated by the LED die 102 is reflected away from the leadframe 104 to be emitted from the LED 100 as useful output light.

The LED die 102 is covered by the multi-layered region 110 of quantum dots, which is described in more detail below. The LED die 102 and the multi-layered region 110 are encapsulated in the encapsulant 112. The encapsulant 112 includes a main section 118 and an output section 120. In this embodiment, the output section 120 of the encapsulant 112 is dome-shaped to function as a lens. Thus, the light emitted from the LED 100 as output light is focused by the dome-shaped output section 120 of the encapsulant 112. However, in other embodiments, the output section 120 of the encapsulant 112 may be horizontally planar. The encapsulant 112 is made of an optically transparent substance so that light from the LED die 102 can travel through the encapsulant and be emitted out of the output section 120 as output light. As an example, the encapsulant 112 can be made of a host matrix, such as polymer (formed from liquid or semisolid precursor material such as monomer), polystyrene, epoxy, silicone, glass or a hybrid of silicone and epoxy.

In an embodiment, the encapsulant 112 may include non-quantum fluorescent material. The non-quantum fluorescent material included in the encapsulant 112 may be one or more types of non-quantum phosphors, such as Garnet-based phosphors, Silicate-based phosphors, Orthosilicate-based phosphors, Thiogallate-based phosphors, Sulfide-based phosphors and Nitride-based phosphors. The non-quantum phosphors may be phosphor particles with or without a silica coating. Silica coating on phosphor particles reduces clustering or agglomeration of phosphor particles when the phosphor particles are mixed with the host matrix to form the encapsulant 112. Clustering or agglomeration of phosphor particles can result in an LED that produces output light having a non-uniform color distribution.

The silica coating may be applied to synthesized phosphor particles by subjecting the phosphor particles to an annealing process to anneal the phosphor particles and to remove contaminants. The phosphor particles are then mixed with silica powders, and heated in a furnace at approximately 200 degrees Celsius. The applied heat forms a thin silica coating on the phosphor particles. The amount of silica on the phosphor particles is approximately 1% with respect to the phosphor particles. Alternatively, the silica coating can be formed on phosphor particles without applying heat. Rather, silica powder can be added to the phosphor particles, which adheres to the phosphor particles due to Van der Waals forces to form a silica coating on the phosphor particles.

The non-quantum fluorescent material included in the encapsulant 112 may alternatively include one or more organic dyes or any combination of non-quantum phosphors and organic dyes.

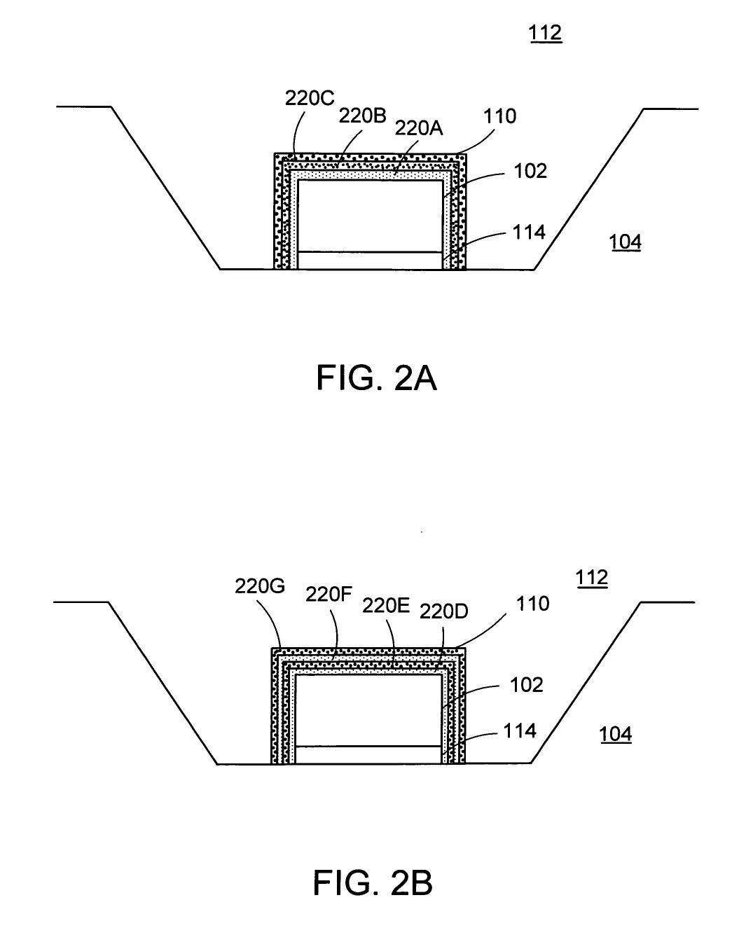

The multi-layered region 110 of quantum dots includes a number of interstitial layers 220 deposited on the LED die 102, as illustrated in FIGS. 2A and 2B. The interstitial layers 220 include quantum dots suspended in a host matrix, which may be the same material used to form the encapsulant 112. Quantum dots, also known as semiconductor nanocrystals, included in the interstitial layers 220 of the multi-layered region 110 are artificially fabricated devices that confine electrons and holes. Typical dimensions of quantum dots range from nanometers to few microns. Quantum dots have a photoluminescent property to absorb light and re-emit different wavelength light, similar to phosphor particles. However, the color characteristics of emitted light from quantum dots depend on the size of the quantum dots and the chemical composition of the quantum dots, rather than just chemical composition as phosphor particles. Quantum dots are characterized by a bandgap smaller than the energy of at least a portion of the light emitted from the LED light source, e.g., the LED die 102.

The quantum dots included in the interstitial layers 220 of the multi-layered region 110 may be quantum dots made of CdS, CdSe, CdTe, CdPo, ZnS, ZnSe, ZnTe, ZnPo, MgS, MgSe, MgTe, PbSe, PbS, PbTe, HgS, HgSe, HgTe and Cd(Si₁₋ₓSeₓ), or made from a metal oxides group, which consists of BaTiO₃, PbZrO₃, PbZr_{z}Ti_{1-z}O₃, BaₓSr₁₋ₓ TiO₃, SrTiO₃, LaMnO₃, CaMnO₃, La₁₋ₓCaₓMnO₃. These quantum dots may or may not be coated with a material having an affinity for the host matrix. The coating passivates the quantum dots to prevent agglomeration or aggregation to overcome the Van der Waals binding force between the quantum dots.

The coating on the quantum dots can be (a) organic caps, (b) shells or (c) caps made of glass material, such as Si nanocrystals. Organic caps can be formed on quantum dots using Ag₂S and Cd(OH)₂, which may preferably be passivated with Cd²⁺ at high pH. A surface modification of the quantum dots is then performed by attaching dyes to the surface of the quantum dots. As an example, CdSe surface surfactant is labile and can be replaced by sequential addition of Se⁺ and Cd²⁺, which can grow to make a seed (quantum dot) larger. For Cd²⁺ rich surface, the surface can be treated with Ph—Se⁻ and an organic coating is covalently linked to the surface. This isolation of molecular particles is referred to as “capped”. Types of known capping molecules include Michelle liquids (Fendler), Tio-terminations (S-based) (Weller-Hamburg), Phosphate termination (Berwandi-MIT), Nitrogen termination (pyridine, pyrazine) and Dendron caps (multi-stranded ligands) (Peng).

Shells are coatings on inner core material (quantum dots). Generally, coating material that forms the shells can be oxide or sulfide based. Examples of shell/core are TiO₂/Cds, ZnO/CdSe, ZnS/Cds and SnO₂/CdSe. For CdSe core, it can also be coated with ZnS, ZnSe (selenide based) or CdS, which improves the efficiency of the CdSe dramatically.

The quantum dots included in the interstitial layers 220 of the multi-layered region 110 may also be coated with a material having affinity for the host matrix to uniformly suspend the quantum dots in the host matrix. This coating material could be organic or inorganic based. As an example, the coating material may be an adhesion promoter material, such as silane. The quantum dots can be coated with the adhesion promoter material by adding the quantum dots into an adhesion promoter solution and stirring well the solution with the quantum dots to ensure that the quantum dot surfaces are completely wetted by the adhesion promoter solution. The solution is then heated to evaporate the adhesion promoter solution, leaving a thin coating of adhesion promoter on the surface of the quantum dots. The coated quantum dots are then mixed into the host matrix.

Another technique to suspend the quantum dots in the host matrix is by adding organic or inorganic dispersants into the host matrix and stirring well the host matrix until the dispersants are homogenously dispersed in the host matrix. The quantum dots are then added to the host matrix. One example of an inorganic material that can be used is silica or silica-based suspension agent.

Each interstitial layer 220 of the multi-layered region 110 includes only quantum dots of a particular particle size range. Thus, the quantum dots can be selectively positioned within the multi-layered region 110 with respect to their particle size. Different sized quantum dots can be positioned at different interstitial layers 220 within the multi-layered region 110 in a predefined order to produce output light having desired wavelength characteristics. The thickness of each interstitial layer 220 can be varied, depending on the desired wavelength characteristics of the output light and the type of light source(s) included in the LED 100. The thickness of some of the interstitial layers 220 can be as thin as the diameter of the largest quantum dots included in that interstitial layer, e.g., approximately 5 microns thick. Alternatively, the thickness of some of the interstitial layers can be hundreds of microns thick. As an example, the total thickness of the multi-layered region 110 may be equal to or less than 100 microns.

As an example, the quantum dots can be arranged within the multi-layered region 110 from smallest to largest in the direction away from the LED die 102, as illustrated in FIG. 2A. In this example, the multi-layered region 110 includes three interstitial layers, a bottom outer interstitial layer 220A (the layer adjacent to the LED die 102), a middle interstitial layer 220B and a top outer interstitial layer 220C (the layer furthest from the LED die). The bottom interstitial layer 220A includes only small-sized quantum dots, which may be quantum dots of approximately 2-3 microns. The middle interstitial layer 220B includes only medium-sized quantum dots, which may be quantum dots of approximately 3-4 microns. The top interstitial layer 220C includes only large-sized quantum dots, which may be quantum dots of approximately between 4-5 microns. Alternatively, the quantum dots can be arranged within the multi-layered region 110 in the reverse order, i.e., from largest to smallest in the direction away from the LED die 102.

As another example, the quantum dots can be arranged within the multi-layered region 110 in an alternating fashion between smaller-sized quantum dots and larger-sized quantum dots, as illustrated in FIG. 2B. In this example, the multi-layered region 110 includes four interstitial layers, a bottom interstitial layer 220D (the layer adjacent to the LED die 102), two middle interstitial layers 220E and 220F and a top interstitial layer 220G (the layer furthest from the LED die). The bottom interstitial layer 220D and the middle interstitial layer 220F include only the larger-sized quantum dots, which may be quantum dots larger than 4 microns. The other middle interstitial layer 220E and the top interstitial layer 220G include only smaller-sized quantum dots, which may be quantum dots of approximately 2-4 microns. Alternatively, the bottom interstitial layer 220D and the middle interstitial layer 220F may include only the smaller-sized quantum dots, while the other middle interstitial layer 220E and the top interstitial layer 220G include only larger-sized quantum dots.

Although the multi-layered region 110 is shown in FIGS. 2A and 2B as including three or four interstitial layers, respectively, the multi-layered region 110 may include two to tens of interstitial layers, depending on the desired optical characteristics of the LED output light.

In operation, the non-quantum fluorescent material included in the encapsulant 112, if any, absorbs some of the original light emitted from the LED die 102, which excites the atoms of the non-quantum fluorescent material, and emits longer wavelength light. Similarly, the quantum dots included in the multi-layered region 110 absorb some of the original light emitted from the LED die 102, which excites the quantum dots, and emit longer wavelength light. The wavelength of the light emitted from the quantum dots partly depends on the size of the quantum dots. In an implementation, the light emitted from the non-quantum fluorescent material and/or the light emitted from the quantum dots are combined with unabsorbed light emitted from the LED die 102 to produce broad-spectrum color light such as white light, which is emitted from the light output section 120 of the encapsulant 112 as output light of the LED 100. In another implementation, virtually all the light emitted from the LED die 102 is absorbed and converted by the non-quantum fluorescent material and/or the quantum dots. Thus, in this implementation, only the light converted by the non-quantum fluorescent material and/or the quantum dots is emitted from the light output section 120 of the encapsulant 112 as output light of the LED 100.

The combination of the light emitted from the non-quantum fluorescent material and the quantum dots of the LED 100 can produce broad-spectrum color light that has a higher CRI than light emitting using only non-quantum fluorescent material or using only quantum dots. The broad-spectrum color output light of the LED 100 can be adjusted by using one or more different LED dies, using one or more different non-quantum fluorescent materials, using one or more different types of quantum dots and/or using different sized quantum dots. In addition, the broad-spectrum color output light of the LED 100 may also be adjusted using non-quantum fluorescent material of phosphor particles with or without a silica coating, using quantum dots with or without a coating and/or using different type of coating on the quantum dots. Furthermore, the ratio between the non-quantum fluorescent material and the quantum dots included in the LED 100 can be adjusted to produce output light having desired color characteristics.

The type(s) of quantum dots included in the multi-layered region 110 may partly depend on the wavelength deficiencies of the non-quantum fluorescent material. As an example, if the non-quantum fluorescent material produces an output light that is deficient at around 600 nm, then a particular type of quantum dots can be selected that can produce converted light at around 600 nm to compensate for the deficiency, which will increase the CRI of the output light.

The encapsulant 112 of the LED 100 may include dispersant or diffusing particles that are distributed throughout the encapsulant. The diffusing particles operate to diffuse light of different wavelengths emitted from the LED die 102, the non-quantum fluorescent material of the encapsulant 112 and/or the quantum dots of the multilayered region 110 so that color of the resulting output light is more uniform. The diff-using particles may be silica, silicon dioxide, aluminum oxide, barium titanate, and/or titanium oxide. The encapsulant 112 may also include adhesion promoter and/or ultraviolet (UV) inhibitor.

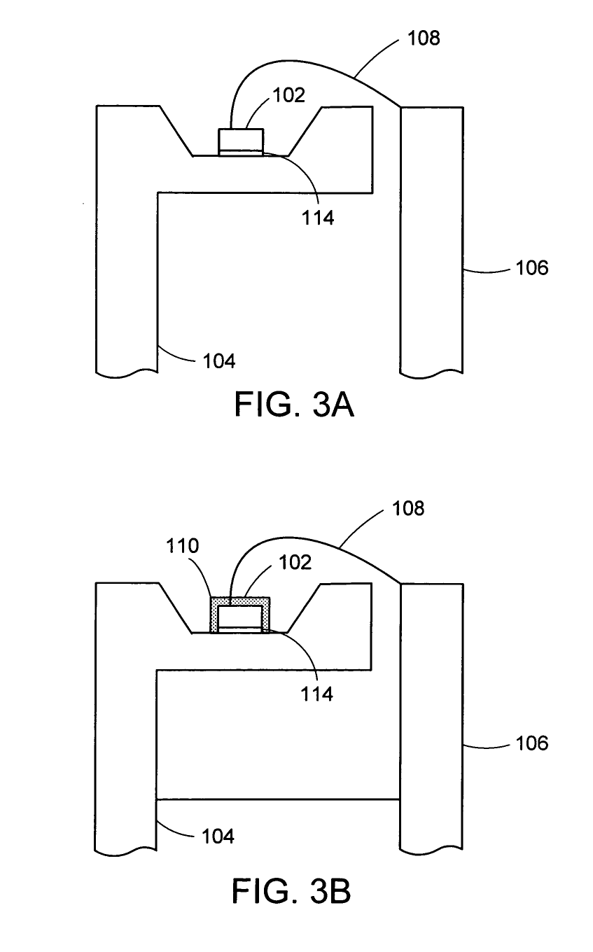

The process for fabricating the LED 100 in accordance with an embodiment of the invention is now described with reference to FIGS. 3A and 3B, as well as FIG. 1. First, the LED die 102 is attached to the mounting structure, i.e., the leadframe 104, using the adhesive material 114. The LED die 102 is then electrically connected to the other leadframe 106 by the bond wire 108, as illustrated in FIG. 3A. Next, the multi-layered region 110 is formed over the LED die 102, as illustrated in FIG. 3B. In order to form the multi-layered region 110, the interstitial layers 220 are sequentially formed over the surface of the LED die 102. The interstitial layers 220 can be formed by depositing the host matrix with the quantum dots over the LED die 102 using a spin-coat deposition, thin film deposition, liquid phase deposition, or evaporation using a solvent solution. In another embodiment, the interstitial layers 220 can be formed over the LED die 102 using a lithographic process or growing thin quantum well semiconductor hetero-structures. Next, the encapsulant 112 is then formed over the multi-layered region 110 and the LED die 102 to produce the finished LED 100, as shown in FIG. 1.

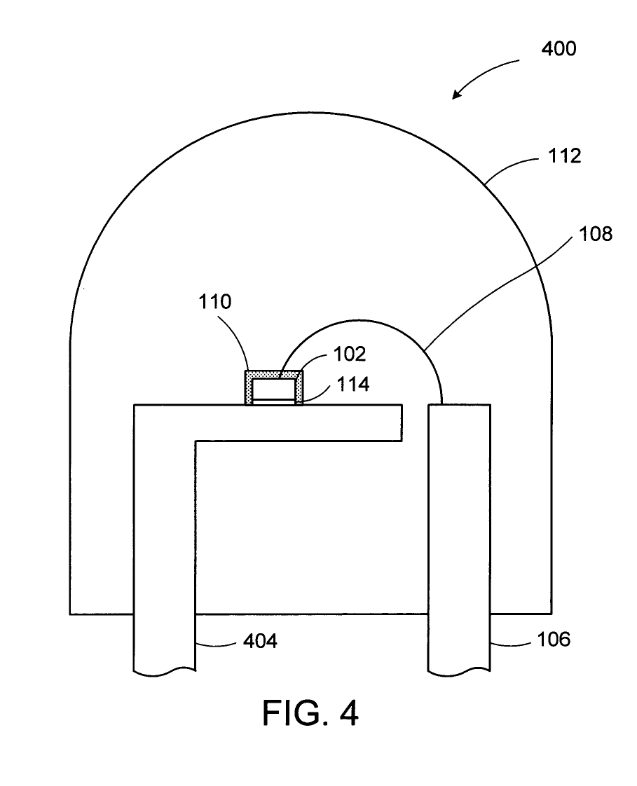

Turning now to FIG. 4, a leadframe-mounted LED 400 in accordance with another embodiment of the invention is shown. The same reference numerals used in FIG. 1 are used to identify similar elements in FIG. 4. In this embodiment, the LED 400 includes a mounting structure, i.e., a leadframe 404, which does not have a reflector cup. Thus, the upper surface of the leadframe 404 on which the LED die 102 is attached is substantially planar.

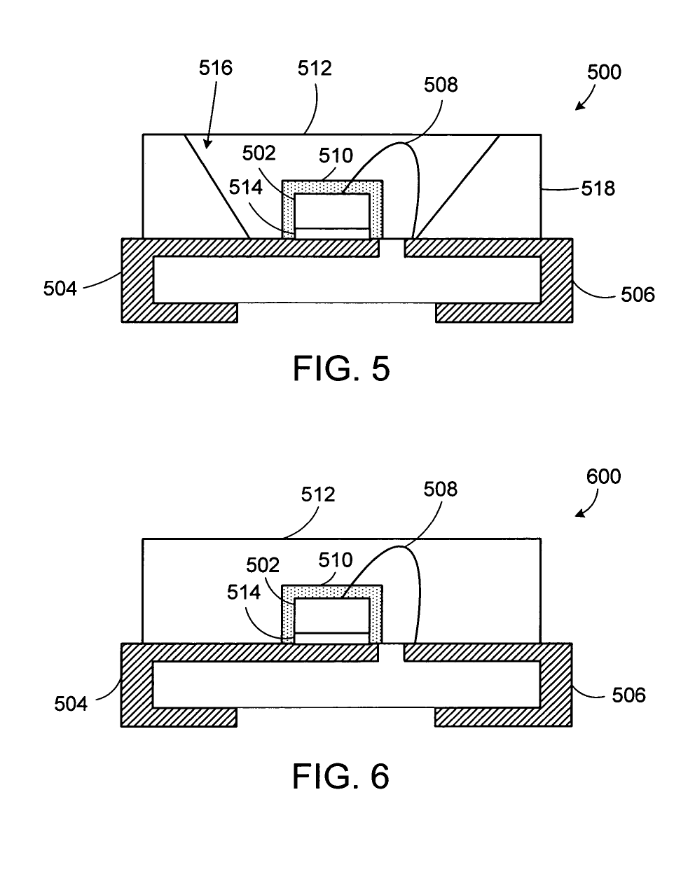

Turning now to FIG. 5, a surface mount LED 500 in accordance with an embodiment of the invention is shown. The LED 500 includes an LED die 502, leadframes 504 and 506, a bond wire 508, a multi-layered region 510 of quantum dots and an encapsulant 512. The LED die 502 is attached to the leadframe 504 using an adhesive material 514. The bond wire 508 is connected to the LED die 502 and the leadframe 506 to provide an electrical connection. The LED 500 further includes a reflector cup 516 formed on a poly(p-phenyleneacetylene) (PPA) housing or a printed circuit board 518. The encapsulant 512 is located in the reflector cup 516. The multi-layered region 510 is positioned over the LED die 502, covering the LED die.

Turning now to FIG. 6, a surface mount LED 600 in accordance with another embodiment of the invention is shown. The same reference numerals used in FIG. 5 are used to identify similar elements in FIG. 6. In this embodiment, the LED 600 does not include a reflector cup.

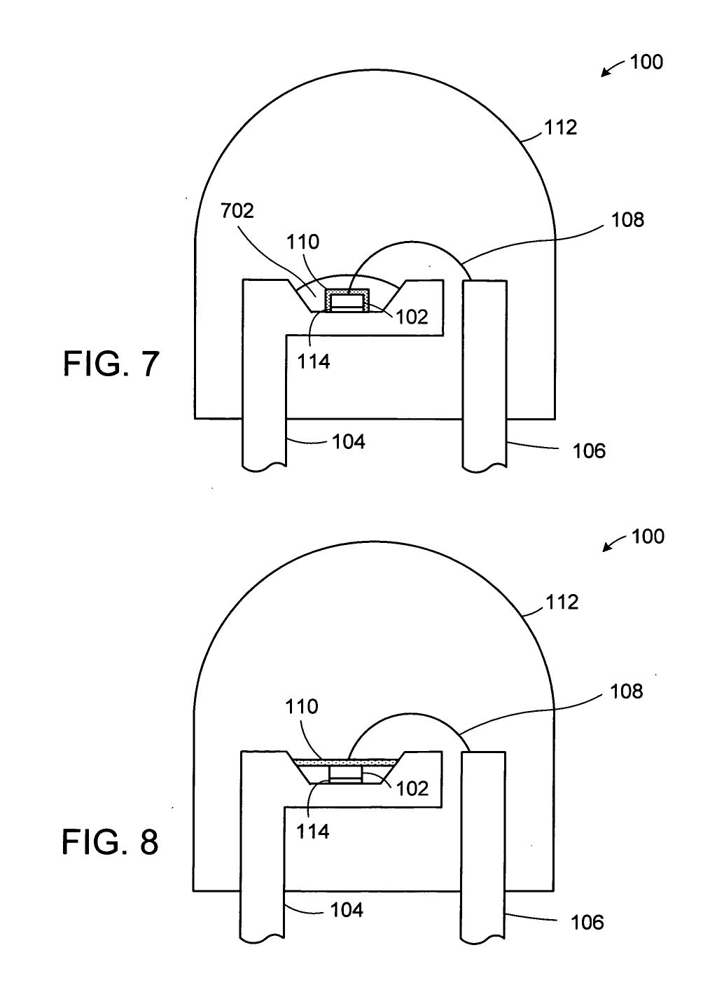

In other embodiments, as illustrated in FIG. 7, the encapsulant 112 of the LED 100 may be configured to create an open space 702 filled with air between the multi-layered region 110 and the encapsulant. The open space 702 provides an air gap between the LED die 102 and the encapsulant 112, which functions as a thermal insulation to protect the encapsulant from the heat generated by the LED die. Excessive heat can significantly deteriorate the optical transmission characteristics of the encapsulant 112, reducing the amount of light emitted from the LED 100. This configuration of the encapsulant 112 can be applied to the other LEDs, such as the LEDs 400, 500 and 600.

Still in other embodiments, as illustrated in FIG. 8, the multi-layered region 110 of the LED 100 may be configured to be planar. In order to form the planar multi-layered region 110, a flat platform at the height of the LED die 102 is made with the encapsulant material. The planar multi-layered region 110 is then formed on the platform. The rest of the encapsulant 112 is then formed over the planar multi-layered region 110. This planar configuration of the multi-layered region 110 can be applied to the other LEDs, such as the LEDs 400, 500 and 600.

Although the invention has been described with respect to LEDs, the invention can be applied to other types of light emitting devices, such as semiconductor lasing devices. In these light emitting devices, the light source can be any light source other than an LED die, such as a laser diode.

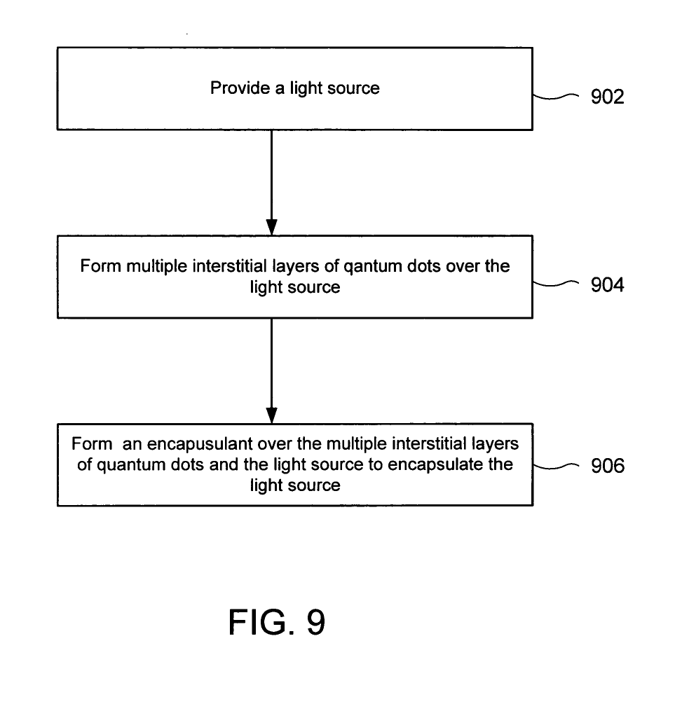

A method for fabricating a light emitting device, such as an LED, in accordance with an embodiment of the invention is described with reference to the process flow diagram of FIG. 9. At block 902, a light source is provided. As an example, the light source may be an LED die. Next, at block 904, multiple interstitial layers of quantum dots are formed over the light source, creating a multi-layered region of quantum dots. Each interstitial layer includes quantum dots of a predefined particle size range. Consequently, different sized quantum dots can be selectively positioned over the light source in the corresponding interstitial layers, as illustrated in FIGS. 2A and 2B. The Next, at block 906, an encapsulant is formed over the multiple layers of quantum dots and the light source to encapsulate the light source.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A device for emitting output light, said device comprising:
a light source that emits original light;
multiple layers of quantum dots positioned over said light source, each of said multiple layers including quantum dots of a predefined particle size range, said multiple layers being positioned to receive said original light and to convert at least some of said original light to converted light, said converted light being a component of said output light; and
an encapsulant positioned over said multiple layers of quantum dots, said output light being emitted from said encapsulant.

2. The device of claim 1 wherein the total thickness of said multiple layers of quantum dots is equal to or less than 100 microns.

3. The device of claim 1 wherein the thickness of at least one of said multiple layers of quantum dots is equal to or less than 5 microns.

4. The device of claim 1 wherein said multiple layers of quantum dots are configured to cover said light source.

5. The device of claim 1 wherein said multiple layers of quantum dots include first layers of quantum dots and second layers of quantum dots, quantum dots included in said first layers being smaller in particle size than quantum dots included in said second layers, said first and second layers being positioned in an alternating fashion.

6. The device of claim 1 wherein each of said multiple layers of quantum dots includes said quantum dots of a different particle size range, said multiple layers being arranged such that said quantum dots of a largest particle size range are located in an outer layer of said multiple layer and said quantum dots of a smallest particle size range are located in another outer layer of said multiple layers.

7. The device of claim 1 wherein said quantum dots include organic caps, quantum dot shells, caps made of glass material or adhesion promoter coating layers.

8. The device of claim 1 wherein said quantum dots include one of CdS, CdSe, CdTe, CdPo, ZnS, ZnSe, ZnTe, ZnPo, MgS, MgSe, MgTe, PbSe, PbS, PbTe, HgS, HgSe, HgTe, Cd(S₁₋ₓSeₓ), BaTiO₃, PbZrO₃, PbZr_{z}Ti_{1-z}O₃, BaₓSr₁₋ₓ TiO₃, SrTiO₃, LaMnO₃, CaMnO₃ and La₁₋ₓCaₓMnO₃.

9. The device of claim 1 wherein said multiple layers of quantum dots include a host matrix, said host matrix being a material selected from a group consisting of polymer, polystyrene, silicone, glass, epoxy or a hybrid~material of silicone and epoxy.

10. The device of claim 1 wherein said encapsulant includes a fluorescent material, said fluorescent material including at least one of phosphor and organic dye.

11. The device of claim 1 wherein said light source includes at least one light emitting diode die.

12. A method for making a light emitting device, said method comprising:
providing a light source;
forming multiple layers of quantum dots over said light source, each of said multiple layers including quantum dots of a predefined particle size range, said multiple layers being used to convert at least some of original light emitted by said light source to control characteristics of output light of said light emitting device; and
forming an encapsulant over said multiple layers of quantum dots.

13. The method of claim 12 wherein said forming said multiple layers of quantum dots includes depositing said multiple layers of quantum dots by one of spin-coat deposition, thin film deposition, liquid phase deposition and evaporation using a solvent solution.

14. The method of claim 12 wherein said forming said multiple layers of quantum dots includes one of forming said multiple layers of quantum dots using a lithographic process and growing quantum well semiconductor hetero-structure.

15. The method of claim 12 wherein the total thickness of said multiple layers of quantum dots is equal to or less than 100 microns.

16. The method of claim 12 wherein forming said multiple layers of quantum dots includes forming first layers of quantum dots and second layers of quantum dots, quantum dots included in said first layers being smaller in particle size than quantum dots included in said second layers, said first and second layers being positioned in an alternating fashion.

17. The method of claim 12 wherein forming said multiple layers of quantum dots includes forming said multiple layers of quantum dots such that each of said multiple layers of quantum dots includes said quantum dots of a different particle size range, said multiple layers being arranged such that said quantum dots of a s largest particle size range are located in an outer layer of said multiple layer and said quantum dots of a smallest particle size range are located in another outer layer of said multiple layers.

18. The device of claim 1 wherein said quantum dots include organic caps, quantum dot shells, caps made of glass material or adhesion promoter coating layers.

19. A device for emitting output light, said device comprising:
a light source that emits original light;
multiple interstitial layers of quantum dots formed on said light source to receive said original light source and convert at least some of said original light to converted light, each of said multiple interstitial layers including quantum dots of a predefined particle size range, said converted light being a component of said output light; and
an encapsulant formed over said multiple interstitial layers of quantum dots, said output light being emitted from said encapsulant.

20. The device of claim 19 wherein said multiple interstitial layers of quantum dots include a first layer of quantum dots and a second layer of quantum dots, quantum dots included in said first layer being smaller in particle size than quantum dots included in said second layer.
